(19) United States
(12) Patent Application Publication
(10) Pub. No.: US 2026/0149397 A1
(43) Pub. Date: May 28, 2026

(54) POSITIONAL NON-LINEARITY COMPENSATION FOR ELECTRIC MOTOR

(71) Applicant: Elaphe propulsion technologies Ltd., Ljubljana (SI)

(72) Inventors: Jure Strle, Ljubljana (SI); Blaž Modic, Lj-Šmartno (SI)

(21) Appl. No.: 19/122,679

(22) PCT Filed: Oct. 19, 2022
(86) PCT No.: PCT/EP2022/079040

§ 371 Date: Apr. 18, 2025

(51) Int. Cl. H02P 21/09; H02P 21/05

(52) U.S. Cl. CPC H02P 21/09; H02P 21/05; H02P 2207/05

(57) ABSTRACT

The disclosure generally relates to non-linearity compensation for electric motors. Exemplary embodiments of the disclosure provide an iterative method for obtaining correction values for compensating positional non-linearity in a synchronous electric motor, computer-readable media storing instructions for performing such method, and a calibration system for coupling to an electric motor.

### BACKGROUND

### Technical Field

This disclosure generally relates to non-linearity compensation for electric motors.

### Description of the Related Art

Various types of alternating current (AC) electric motors are used in industry, railways, electric and hybrid vehicles, etc. One example of such electric motors are synchronous electric motors, and specifically permanent magnet synchronous electric motor. In such type of electric motor, a multi-phase alternating current flowing through stator windings rotates a rotor synchronously with the frequency of the magnetic field. Running a permanent magnet synchronous electric motor commonly requires controlling the multi-phase alternating current according to the position of the rotor. The mechanical angle of the rotor is tied to the rotating magnetic field, i.e., the electrical angle of the supplying currents. The mechanical angle can be obtained in different ways, for example, using a Hall device, encoders, resolvers or even without using any external sensors.

When using position sensors to measure the mechanical angle of the rotor in a synchronous electric motor, the position sensors are commonly affected by the inherent non-linearity of the sensor readings to conclude on the mechanical angle. Often the resolvers are used. The output signals of the resolver are in the form of sine and cosine signals of the rotating angle of the rotor and are processed to obtain the absolute mechanical angle of the rotor at a given resolution, i.e., a given number of bits (usually more than 12 bits). Besides errors due to random noise in the output signals of the position sensors, additional systemic errors, such as a non-linear response, are also an issue.

Errors due to random noise can be separated from the systemic error, such as sensor non-linearity, and appropriate methods to compensate random noise-based errors can be applied. For example, random noise can be filtered out by various methods, while systemic errors are more difficult to detect and remove from the raw sensor signal readings.

US 2011/0260663 A1 discloses a method for compensating nonlinearity of a resolver to control a motor in hybrid and fuel cell vehicles, thereby stably controlling the motor current during high-torque and high-speed operation. The method is applicable during rotation at a constant low speed. It uses resolver output data and under the assumption of constant speed rotation and finds the theoretically correct mechanical angle of the rotor. It then stores the data into a read-only memory to be used for error correction during operation. The low-speed requirement is particularly limiting, as it is often desired to perform the non-linearity compensation at a higher speed.

U.S. Pat. No. 7,895,010 B2 discloses a method of improving position detection by using the first n terms of Fourier transformation on angular velocity signal defined in m divisions. The resulting error table is then used for angle signal correction. Spectral analysis is computationally intensive.

US 2015/0158396 A1 discloses a method of angular error correction by performing spectral analysis of a signal indicating the angle of the rotor and using the amplitudes and phases of the harmonics to compensate for the error for many different speed points. As mentioned earlier, spectral analysis is computationally intensive, and the absence of further compensation does not necessarily remove the error sufficiently.

Synchronous electric motors, including for example, permanent magnet synchronous electric motors, are commonly controlled using vector control methods such as direct or indirect field-oriented control (FOC). Vector control of multi-phase synchronous AC electric motors is typically based on a variable-frequency drive (VFD) control method. In such control methods, the stator currents of the multi-phase AC are identified as two orthogonal components representing the magnetic flux and torque, and the two components are commonly visualized by a vector.

Synchronous electric motors are often controlled using signals from a position sensor to correctly calculate the voltage and current vectors in the rotating reference frame from the Clarke-Park equations. Small oscillations due to random noise will be inherent to the sensor readings from the positional sensors. Yet, the geometric and magnetic imperfections of the electric motor and the position sensor result also in periodic oscillations of position and voltage/current vectors with the frequency corresponding to a single motor revolution. Thus, geometric and magnetic imperfections of the electric motor and the position sensor result cause the measurements of the physical rotor position by the position sensor to not perfectly follow the physical rotor angle which introduces rotational non-linearity in the sensor data from the position sensor. The measurements of the physical rotor position by the position sensor are thus not perfectly translated into the measured value of the electrical angle used for FOC control, which can decrease the efficiency of the electric motor and/or can induce low-frequency vibrations. For example, for in-wheel synchronous electric motors controlled by a position sensor-based FOC scheme, those low-frequency vibrations can negatively affect noise, vibration and harshness (NVH) of the vehicle.

### BRIEF SUMMARY

This Brief Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The disclosure has been generally made in the light of the above noted geometric and magnetic imperfections of electric motors and the position sensors that result also in periodic oscillations of position and voltage/current vectors of the FOC scheme used to drive the electric motor. The embodiments of the disclosure generally relate to compensating unwanted effects of geometric and magnetic imperfections of electric motors and the position sensors on the motor control scheme that cause non-linearity in the position sensor measurements. Exemplary embodiments of the disclosure provide an iterative method for obtaining correction values for compensating positional non-linearity in a synchronous electric motor, non-transitory computer-readable media storing instructions for performing such method, and a calibration system for coupling to an electric motor.

In the light of the above, the embodiments of the disclosure aim at compensating (at least partially) rotational non-linearity in the sensor data from the position sensor of an electric motor. The compensation of the rotational non-linearity in the position sensor readings may be, for example, realized using a look-up table (also referred to as a “correction table” herein below) which stores correction values. The look-up table may be stored in a non-volatile memory which can be accessed by the vector control. During use of the electric motor, these correction values are to be used by the vector control of the electric motor for correcting an (angular) error in the position sensor signal reflecting the physical position/angle of the rotor obtained from the position sensor, so as to achieve a more linear rotation of the rotor of the electric motor. The compensation can be considered part of the FOC control scheme itself or can be performed prior to FOC control, i.e., FOC control can be based on the corrected position sensor signals. One aspect of the disclosure is to provide embodiments of iterative methods for determining the correction values that are to be stored in the correction table for correction of the position sensor signals obtained by the position sensor of the electric motor. In example implementations of those embodiments, the determination of the correction values may be computationally less intensive, as the determination can be based on position sensor readings and does not require or use spectral analysis of the position sensor readings. In some embodiments, the determination (and storage) of the correction values may be performed for the electric motor once (e.g., upon its calibration), assuming that the geometric and magnetic imperfections of the given electric motor and its position sensor are not changing over lifetime of the electric motor.

It is to be noted that reference to a “position sensor” (in singular) is made herein above and in the following for simplicity only. A position sensor may generally include one or more individual sensor elements (e.g., multiple Hall sensors or position encoders), each of which may provide sensor data at each given measurement instance. In line with this understanding, a position sensor “reading” or position sensor “signal” herein may denote a signal received from the position sensor that corresponds to a given measurement instance and indicative of the absolute position (i.e., the mechanical angle) of the rotor of the electric motor at the given measurement instance. This position sensor “reading” or “signal” corresponding to a given measurement instance may be based on the sensor data of the one or more multiple sensor elements of the position sensor measured at the given measurement instance. For example, the position sensor may provide a position sensor “reading” or “signal” indicative of the absolute position of the rotor in periodic intervals (i.e., at a given frequency). There may be multiple measurement instances in a single revolution of the rotor, so that the measurement instances, and thus position sensor readings/signals, are associated with mechanical positions of the rotor.

In accordance with the above, an embodiment of the disclosure provides an iterative method for obtaining correction values for compensating positional non-linearity of a rotor of a synchronous electric motor (e.g., a permanent magnet synchronous machine, PMSM). It is assumed that a single revolution of the rotor is divided into N mechanical positions. In a step (1) of the iterative method, the electric motor is controlled to run at a constant speed based on a field-oriented control (FOC) scheme. The FOC scheme may for example use the D-Q (Direct-Quadrature) coordinate system. In such FOC scheme, a flux control signal V_{d} controls the magnetic flux in the electric motor.

The iterative method further comprises a step (2) of determining, for each of the i=1, . . . , N mechanical positions of the rotor and for each of a predetermined number M of one or more revolutions of the rotor of the electric motor running at the constant speed, one or more instantaneous flux control values using the field-oriented control scheme, wherein the instantaneous flux control values are based on respective position signals indicative of the absolute position of the rotor of the electric motor corresponding to the N mechanical positions and the predetermined number M of one or more revolutions.

The iterative method further comprises a step (3) of filtering the instantaneous flux control values determined in step (2) for each of the N mechanical positions to obtain a respective filtered instantaneous flux control value representing oscillation of the magnetic flux for each of the N mechanical positions.

Step (4) of the iterative method multiplies the N filtered instantaneous flux control values with a scaling factor. The scaling factor may impact convergence of the iterative process of determining the optimal correction values for an angular error of the rotor corresponding to the N mechanical positions. For example, the scaling factor could be selected, set or configured to optimize convergence of the iterative process in a given/predetermined number of iterations (see step (6)).

In a step (5) of the iterative method, the correction values are updated for an angular error of the rotor corresponding to the N mechanical positions in a compensation table based on the scaled and filtered instantaneous flux control values.

In a step (6) of the method, steps (2) to (5) are repeated using the updated correction values for an angular error of the rotor in the updated compensation table until reaching a predetermined number of iterations.

In a further embodiment of the disclosure, the steps (2) to (6) are repeated for each of a plurality of shift values, to obtain a compensation table storing a respective set of updated correction values for an angular error of the rotor corresponding to the N mechanical positions for each of the shift values. For example, the shift values may represent shifts of the mechanical angle of the rotor in the range exclusive 0° to inclusive 20°. The correction values for an angular error of the rotor in the compensation table are reset to zero for each of the shift values before steps (2) to (6) are repeated for the respective shift value. Further, in step (5), each of the correction values for an angular error of the rotor corresponding to a respective scaled and filtered instantaneous flux control value at a given mechanical position i is updating the shifted entry of the compensation table corresponding to the ((i+shift value)MOD N)^{th} mechanical position, where MOD is the modulo operation and i represents the

In a further embodiment, the following steps may be performed in the last iteration of the predetermined number of iterations for the different shift value: In a step (7), for each of the shift values, a standard deviation of the N scaled and filtered instantaneous flux control values is determined in the last iteration for the respective shift value, and in a step (8), for each of the shift values, the set of updated correction values for an angular error of the rotor corresponding to the N mechanical positions for the respective shift value and the standard deviation of the N scaled and filtered instantaneous flux control values for the respective shift value is stored in the compensation table.

According to a further embodiment, the iterative method may further comprise selecting the set of correction values for an angular error of the rotor corresponding to the N mechanical positions corresponding to the shift value that results in the smallest standard deviation of the N scaled and filtered instantaneous flux control values as the final set of correction values for an angular error of the rotor corresponding to the N mechanical positions; and storing the selected set of correction values for an angular error of the rotor corresponding to the N mechanical positions in a final compensation table in a non-volatile memory for control of the magnetic flux in the electric motor based on the field-oriented control scheme. It should be noted that in case no shift values are used in the manner described above, the one set of correction values for an angular error of the rotor corresponding to the N mechanical positions generated by the iterative process is used as the final set and stored in the final compensation table for control of the magnetic flux in the electric motor based on the field-oriented control scheme.

According to a further embodiment, the filtering in step (3) comprises removing electric harmonic oscillations from the instantaneous control values determined for the N mechanical positions to smooth the instantaneous control values determined for the N mechanical positions. For example, in some implementation examples, the electric harmonic oscillations are removed from the instantaneous control values determined for the N mechanical positions by digital low-pass filtering or another known technique.

According to another embodiment the filtering in step (3) further comprises (in addition to low-pass filtering, or alternatively) averaging the instantaneous flux control values corresponding to each of the N mechanical positions to obtain the instantaneous control values corresponding to the respective mechanical position.

In another embodiment, the iterative method further comprises measuring the position signal indicative of the absolute position of the rotor of the electric motor using a position sensor at a sampling frequency so that at least one, preferably multiple instantaneous flux control values is/are determined in step (2) for each of the N mechanical positions.

In the embodiments of the disclosure, the electric motor may comprise a number p of pole pairs, where p≥2, preferably p≥20 and more preferably p≥28. While the iterative method can be used with an electric motor having two pole pairs only, the accuracy of the iterative process to determine the correction values may increase with the number of pole pairs, as harmonics can be filtered more efficiently for higher number of pole pairs. In addition, or alternatively, the number of revolutions of the rotor in each iteration may be in a range inclusive 1 to inclusive 100, preferably in a range inclusive 10 to inclusive 30. In addition, or alternatively, the predetermined number of iterations is in the range inclusive 3 to inclusive 20, preferably in the range inclusive 7 to inclusive 10.

Another embodiment of the disclosure provides a computer-readable medium storing instructions that, when executed by a processing unit of an apparatus, cause the apparatus to perform the iterative method according to one of the different embodiments disclosed herein.

A further embodiment of the disclosure provides a calibration system for coupling to an electric motor, the system comprising a processing unit and memory storing instructions, wherein the processing unit is configured to execute the instructions stored in memory to cause the calibration system to perform the iterative method according to one of the different embodiments disclosed herein.

### BRIEF DESCRIPTION OF THE SEVERAL VIEWS OF THE DRAWINGS

The present description will be better understood from the following detailed description read in light of the accompanying drawings, wherein like reference numerals are used to designate like parts in the accompanying description.

FIG. 1 shows a schematic control scheme for use with a synchronous electric motor according to an embodiment of the present disclosure;

FIG. 2 shows in its upper portion an example of a real-life response of a position sensor for one revolution of the rotor (bold line) and an ideal linear behavior (dotted line) assuming constant speed of the electric motor at 500 rpm and performing sensor readings at a frequency of 10 kHz, and in its lower portion, the deviation of the real response of a position sensor from the ideal linear sensor response;

FIG. 3 exemplifies a real-life oscillation of the flux control signal V_{d} in one full revolution of the rotor of an electric motor and its correlation to the observed rotational nonlinearity Derr.

FIG. 4 shows an iterative positional nonlinearity compensation method according to an embodiment of the disclosure;

FIG. 5 shows another iterative positional nonlinearity compensation method according to an embodiment of the disclosure;

FIG. 6 shows the resulting fluctuations of the flux control signal V_{d} and corresponding correction values ρ_{correct} obtained for the mechanical positions of the electric motor in iterations 0, 1, 3 and 7 of steps 404 to 410 in FIG. 4; and

FIG. 7 shows an example device according to an embodiment of the disclosure.

### DETAILED DESCRIPTION

Different embodiments of the disclosure will be outlined in the following in more detail. The disclosure generally relates to non-linearity compensation for electric motors, for example, synchronous electric motors. Exemplary embodiments of the disclosure provide an iterative method for obtaining correction values for compensating positional non-linearity in a synchronous electric motor, non-transitory computer-readable media storing instructions for performing such method, and a calibration system for coupling to an electric motor.

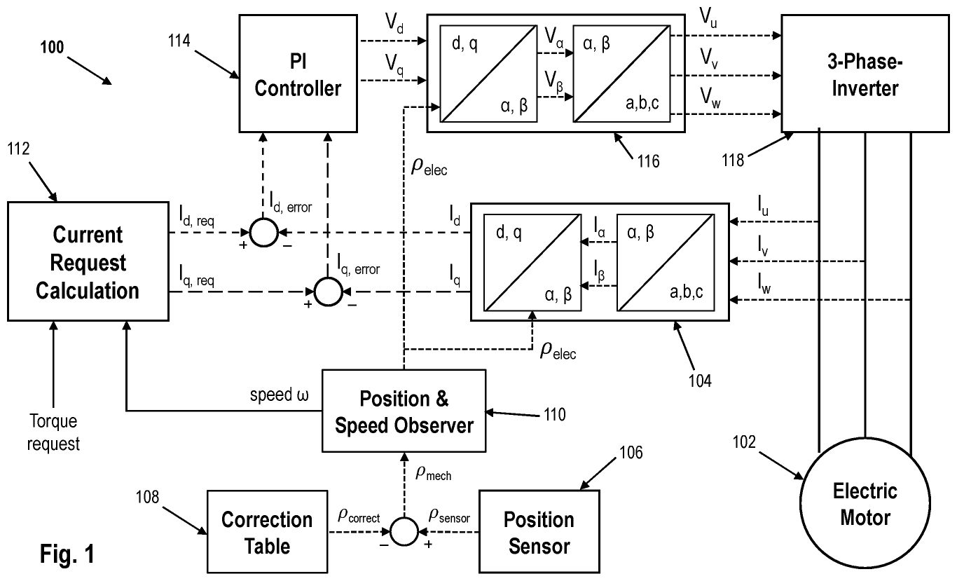

FIG. 1 shows a schematic control system 100 for use with a synchronous electric motor 102 according to an embodiment of the disclosure. The control system 100 is represented by the functional blocks 104-118. In some example embodiments, the functional blocks 104-118 may be implemented in a device 700. The functional blocks 104-118 may be implemented for example by means of one or more integrated circuits (including but not limited to one or more of a non-volatile memory, a FPGA, a DSP, a PLD, an ASIC, etc.). The functionality performed by the functional blocks 104-118 as outlined herein below may be either implemented in hardware (e.g., by means of hardwired circuit(s)) or in software, or by a combination of hardware and software. In an example embodiment, one or more of functional blocks 104-118, or all functional blocks 104-118 may be implemented in a system-on-chip (SoC) or system-in-package (SoP), which may be provided/mounted on a circuit board, such as a printed circuit board (PCB), providing an interface to the electric motor 102.

The control system 100 used in this example embodiment implements a vector control scheme, e.g., a FOC control scheme. The FOC controls the components of the motor stator currents, represented by a vector, in a rotating reference frame d, q aligned with the rotor. The rotor current system is commonly described using an equivalent quantity defined by rotating system coordinates of the reference fame d, q following the rotor flux. The electric torque of the electric motor 102 can be described by the interaction between the rotor currents and the flux wave resulting from the stator currents induction.

The Clarke/Park block 104 receives the three-phase currents Iᵤ, Iᵥ and I_{w} provided by the 3-phase inverter 118 to drive the electric motor 102 according to a torque request signal. The Clarke/Park block 104 implements a Clarke- and Park-transformation. Hence, block 102 represents the three-phase stator current system of the synchronous electric motor 102 as an orthogonal two-phase system with two parameters. These two parameters form the current space vector used to directly control the flux linkage and torque of the electric motor. The Clarke/Park block 104 may perform a coordinate transformation into a two-phase system making use of α-β-transformation (also denoted Clarke-transformation) describing a transformation of the three-phase currents Iᵤ, Iᵥ and I_{w} obtained by the phase current sensors (not shown) to a two-phase system with a rectangular coordinate system which is fixed to the stator (i.e., a stationary coordinate system). The Clarke transform implemented in Clarke/Park block 104 calculates currents I_{α} and I_{β} in the two-phase orthogonal stator axis from the three phase currents Iᵤ, Iᵥ and I_{w}. These two currents I_{α} and I_{β} in the fixed coordinate stator phase are transformed further to the current components I_{d} and I_{q} in the d, q frame using a D-Q-transformation (also denoted Park-transformation) based on the electric angle ρ_{elec} of the rotor provided by the position and speed observer block 110. It is to be noted that the Clarke/Park block 104 is not required to perform the Clarke-transform and Park-transform separately in sequence as described herein above, but the block 102 may also implement a joint Clarke-/Park-transform process, which takes the three-phase currents Iᵤ, Iᵥ and I_{w} as an input and outputs the to the current components I_{da} and I_{q} in the d, q frame.

The current components I_{d} and I_{q} provided by Clarke/Park block 104 are used to calculate the error current signals I_{d,error} and I_{q,error} relative to the requested current components lI_{d,req} and I_{q,req}, which are provided by the current request calculation block 112, where the I_{d,error}=I_{d,req}−I_{d} and I_{q,error}=I_{q,req}−I_{q}. The requested current components I_{d,req} and I_{q,req} may be determined by the current request calculation block 112 based on control parameters, e.g., a torque request command (torque request) and the determined instantaneous motor speed @ of the electric motor 102 received from the position and speed observer block 110. One or more of the control parameter(s) input to the current request calculation block 112, such as the torque request command (torque request), may be for example received from an external entity, e.g., a motor controller of an electric vehicle.

The error current signals I_{d,error} and I_{q,error} are used by the proportional integral (PI) controller block 114 to generate a flux control signal V_{d}, which may be a voltage signal, based on the current signal I_{d,error} and a torque control signal V_{d}, which may be a voltage signal, based on the current signal I_{q,error}. As their names suggest, the flux control signal V_{d} is for controlling the magnetic flux in the electric motor 102, whereas the torque control signal V_{d} is for controlling the torque of the electric motor 102. The flux and torque control signals V_{d} and V_{q} and the electric angle ρ_{elec} of the rotor provide by the position and speed observer block 110 are input to the Inverse Clarke/Park block 116, which transforms the two-dimensional control vector formed by the flux and torque control signals V_{d} and V_{q} into a three-dimensional voltage system for control of the electric motor 102. Inverse Clarke/Park block 116 substantially performs the inverse operations of the Clarke/Park block 104: The flux and torque control signals V_{d} and V_{q} are subjected to an inverse Park-transform and subsequently the resultants transformed flux and torque control signals V_{α} and V_{β} are subjected to an inverse Clarke-transform to obtain control signals V_{u,PMW}, V_{v,PMW} and V_{w,PMW}. Although described as sperate and sequential inverse transforms, the Inverse Clarke/Park block 116 may also implement the inverse Clarke-/Park-transforms jointly in a process, which takes the flux and torque control signals V_{d} and V_{q} in the d, q frame as an input and outputs the control signals Vᵤ, Vᵥ and V_{w}. The Inverse Clarke/Park block 116 may optionally perform a pulse-width-modulator (PWM) on the control signals control signals Vᵤ, Vᵥ and V_{w} produced by the inverse Clarke-transform to obtain the control signals V_{u,PMW}, V_{v,PMW} and V_{w,PMW}, so that the control signals V_{u,PMW}, V_{v,PMW} and V_{w,PMW} have the desired duty cycles and/or phase shifts relative to each other for causing the 3-phase inverter circuit 118 to drive the stator of the synchronous electric motor 102.

Although the control system 100 operates responsive to a torque request command, the control system 100 could also operate based on requested motor speed or both. In those cases, the current request calculation block 112 would take the relevant control parameter(s) (optionally together with the electric angle ρ_{elec} and/or motor speed @ of the electric motor 102) as inputs for determining the requested current components I_{d,req} and I_{q,req}. Furthermore, the disclosure is not limited to the specific implementation and operations of the functional blocks 104.

The position and speed observer block 110 provides electric angle ρ_{elec} of the rotor to the Clarke/Park block 104 and the Inverse Clarke/Park block 116 and a motor speed @ to the current request calculation 112. In conventional implementations of sensor-based FOC, the position and speed observer block 110 typically receives position signals ρₛₑₙₛₒᵣ indicative of the absolute position of the rotor of the electric motor 102 at the given sampling times of the position sensor 106. In the example implementation, the position signal ρₛₑₙₛₒᵣ may indicate the instantaneous mechanical angle of the rotor relative to a reference point as measured by the position sensor 106 at a given sampling time. The position sensor 106 may provide individual measurements of the instantaneous mechanical angle of the rotor as sensor data at a given sampling or measurement rate or frequency. The position sensor 106 is not limited to a particular sensor type and may be any sensor that provides an indication of the mechanical angle of the rotor of the electric motor 102 measures/sampled at a given sampling time. Position sensor 106 may include one or more individual sensor elements (e.g., multiple Hall sensors or position encoders), each of which may provide sensor data at each given measurement instance. A position sensor reading, or position sensor signal herein may thus denote a signal received from the position sensor 106 that corresponds to a given measurement instance and indicative of the absolute position (i.e., the mechanical angle) of the rotor of the electric motor 102 at the given measurement instance.

As will be outlined in more detail below, geometric and magnetic imperfections of electric motor 102 and the position sensor 106 (e.g., the one or more sensor elements thereof) impose a non-linearity of individual instances of the position signal ρₛₑₙₛₒᵣ measured during a single revolution of the rotor by the position sensor 106. These non-linearity on the sensor readings can lead to periodic oscillations of the voltage/current vectors of the FOC scheme produced by the control system 100 used to drive the electric motor 102. To compensate for those non-linearities in the position sensor 106's position sensor readings, the position signals ρₛₑₙₛₒᵣ measured by the position sensor 106 are corrected by applying correction values ρ_{correct} from an error correction table 108 so as to provide the mechanical angle ρ_{correct} to the position and speed observer block 110 (e.g., ρ_{mech}=ρₛₑₙₛₒᵣ−ρ_{correct}). The correction values ρ_{correct} in the error correction table 108 may correspond to respective ones the N mechanical positions. The correction values ρ_{correct} may correct the angular error θ_{err,i} of the rotor corresponding to the N mechanical positions.

In the embodiment of FIG. 1, the position sensor 106 is used to measure the mechanical angle of the rotor of the electric motor 102. The output from the position sensor 106 is the absolute angle of the rotation ρₛₑₙₛₒᵣ. Without applying the correction from correction table 108 in FIG. 1, the mechanical angle ρₛₑₙₛₒᵣ=ρ_{mech}, i.e., the angle ρₛₑₙₛₒᵣ would be transformed into the electrical angle ρ_{elec} by the position and speed observer block 110 that corresponds to the rotating magnetic field in the electric motor 102. Depending on the number p of pole pairs (PP) of the electrical motor 102, the electric angle ρ_{elec}=p·ρ_{mech} which is equal to p·ρₛₑₙₛₒᵣ if no angle correction is performed. Hence, every revolution of the rotor presents p revolutions of the magnetic field in the electric motor 102. The electric angle ρ_{elec} is used in the FOC control described in connection with FIG. 1 above.

When rotating the rotor of the electric motor 102 at constant angular velocity, the change in rotor position should be linear with time. Due to geometric and magnetic imperfections of the position sensor 106 and the motor 102, the measured rotor position represented by the mechanical angle ρₛₑₙₛₒᵣ is not increasing linearly, but slightly fluctuating around the linear behavior. This rotational nonlinearity has a periodicity corresponding to the frequency of the revolutions of the rotor. The rotational nonlinearity in the measured mechanical angle ρₛₑₙₛₒᵣ (when not corrected) affects the motor control by introducing speed oscillation in the otherwise steady rotation. Nonlinearity may negatively impact motor control and can induce noticeable vibrations and reduce efficiency.

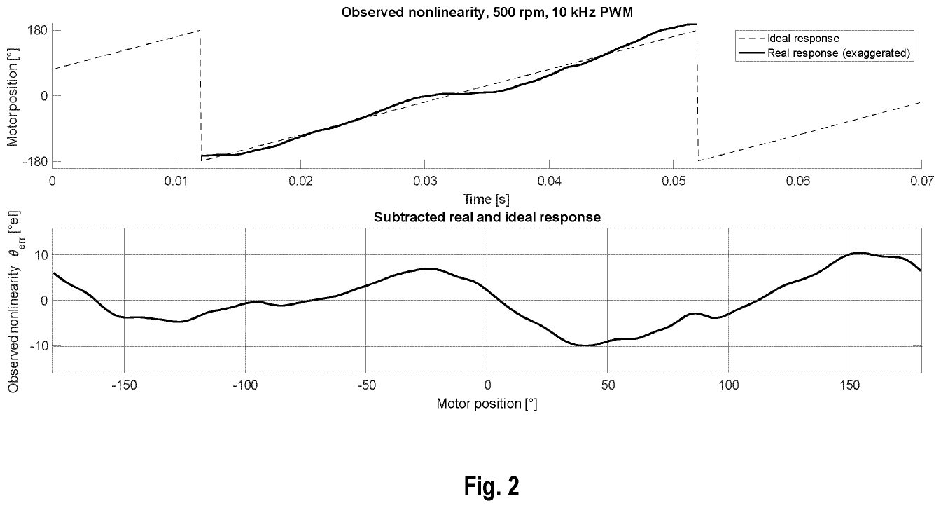

It is typically not feasible to measure and compensate rotational nonlinearity directly. The upper portion of FIG. 2 shows an example of a real-life response of a position sensor 106 for one revolution of the rotor (bold line) and an ideal linear behavior (dotted line) assuming constant speed of the electric motor 102 at 500 rpm and performing sensor readings at a frequency of 10 kHz. The lower part of FIG. 2 shows the deviation of the real response of a position sensor 106 from the ideal linear sensor response. The subtraction of the ideal linear response of the position senor 106 from the real response of the position sensor 106 results in a periodic oscillation around 0, which is referred to as the observed rotational nonlinearity θₑᵣᵣ in the following. The observed rotational nonlinearity θₑᵣᵣ can be assumed to be a rough estimate of the underlying actual rotational nonlinearity η. The electrical angle ρ_{elec} [° el] is mechanical angle ρₛₑₙₛₒᵣ=ρ_{mech} [°] multiplied by the number p of pole pairs. In the example in FIG. 2, there are p=28 pole pairs. This number of pole pairs is of course an example only.

Due to the closed-loop nature of the control system 100, the nonlinearity n (if not compensated) affect the motor control, slightly accelerating the rotor in some parts, and slightly decelerating in other parts of the revolution of the rotor. This affects the rotation and further modifies the rotational nonlinearity, which again affects the motor control, etc., with increasingly smaller modifications until it stabilizes. To compensate, just simply subtracting the initially observed rotational nonlinearity θ_{err.1} from the position sensor signal may partly compensate for the rotational nonlinearity, but the difference between actual and observed nonlinearities still manifests as remnant nonlinearity η_{rem,1} (n−θ_{err,1}), which would be measured as in the observed nonlinearity θ_{err,2}. When iterating the compensation for this remnant nonlinearity η_{rem,1}, the compensation of the rotational nonlinearity should become better for each iteration. After i=n iterations the final observed rotational nonlinearity θ_{err,total} would be a sum of all the contributions from each iteration and fairly close to the rotational nonlinearity η≈θ_{err,total}=θ_{err,1}+θ_{err,2}+θ_{err,3}+θ_{err,4}+ . . . θ_{err,n}, while the remnant rotational nonlinearity η_{rem,n}=(η−θ_{err,total})≈0. Based on this understanding, one aspect of this disclosure proposes an iterative method for finding correction values for compensating the rotational nonlinearity so that the remnant rotational nonlinearity η_{rem,n} is minimized.

As explained in connection with FIG. 2, rotational nonlinearity is a periodic function over one mechanical revolution of the rotor and covers −a p times lower frequency spectrum than the electric harmonics (p being the number of pole pairs of the electric motor 102), which are periodic oscillations tied to the motor's electric cycles. However, rotational nonlinearity affects other electric quantities observed by the motor control. The calculated current and voltage components in the rotating reference frame (I_{q}, I_{d}, V_{q}, V_{d})—ideally—would be constant at a constant speed, but due to the rotational nonlinearity in the in the mechanical angle ρₛₑₙₛₒᵣ provided by the position sensor 106 they exhibit periodic oscillations over one mechanical revolution (mechanical harmonics) of the rotor. By compensating for the overall nonlinearity in the mechanical angle ρₛₑₙₛₒᵣ measured by the position sensor 106, these mechanical harmonics in the electric quantities can also be reduced.

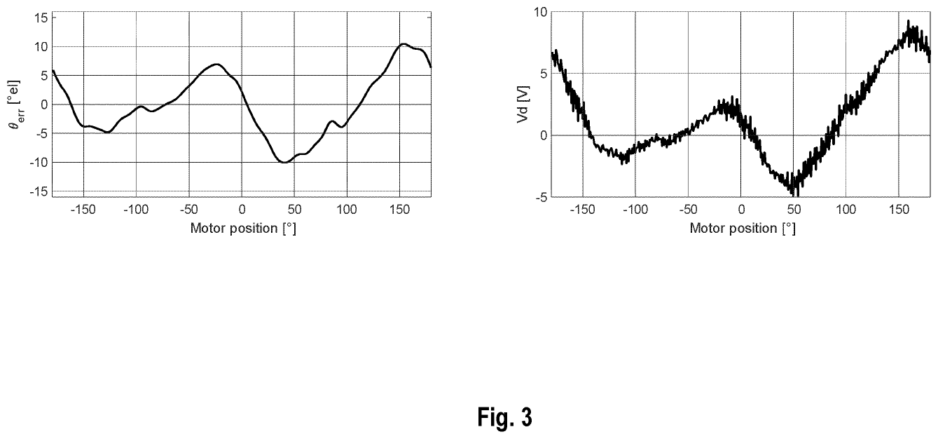

When the motor is running at a constant speed, only a small working torque is required, which corresponds to a small current component I_{q} and near-zero current component I_{d}. The electric angle ρ_{elec} follows the mechanical rotation of the rotor with only a small phase shift between the phase currents and the rotor magnets. The rotational nonlinearity of the rotor's mechanical position as measured by the position sensor 106 results in an error in this phase shift which is captured as an oscillation of the flux control signal V_{d} [V] that is strongly correlated to the observed rotational nonlinearity θₑᵣᵣ as shown in FIG. 3. When iteratively correcting the electric angle ρ_{elec} for the rotational nonlinearity, the oscillation of the flux control signal V_{d} will converge to zero and it is thus possible to obtain correction values (ρ_{correct}) for correction table 108 for positional error correction by summing oscillations of the flux control signal V_{d} from each iteration. To ensure convergence of the iterative process, a proper scaling factor and phase shift between oscillations of the flux control signal V_{d} and the observed nonlinearity θₑᵣᵣ may be determined/set. Nonlinearity compensation in accordance with the embodiments of the disclosure may be performed in a controlled environment at a given, constant angular velocity of the electric motor 102. The result of the iterative process are correction values (ρ_{correct}) associated with respective mechanical positions of the rotor which can be stored in a look-up table (correction table 108). The look-up table 108 may be referenced to correct the position sensor readings (ρₛₑₙₛₒᵣ) by subtracting the look-up table entries (ρ_{correct}) as shown in FIG. 1, wherein the electrical angle ρ_{elec} is based on the corrected mechanical angle, the electrical angle being ρ_{elec}=ρₛₑₙₛₒᵣ−ρ_{correct}.

As outlined in more detail below, one revolution of the rotor (corresponding to 360°=2π rad) can be divided into a number of N mechanical positions, where N is an integer multiple of the number p of pole pairs. The correction for the rotational nonlinearity in the position sensor readings maybe performed per mechanical position, i.e., ρ_{elec,i}=ρ_{sensor,i}−ρ_{correct,i} where i=[1, . . . , N]. To measure and quantify the level of nonlinearity, the iterative process uses the instantaneous values of the flux control signal V_{d,i} corresponding to the respective mechanical positions and, optionally, the standard deviation σ_{Vd} of the flux control signals V_{d,i} corresponding to the N mechanical positions after having performed the desired number of iterations. When referring to parameters, e.g., mechanical angle ρₛₑₙₛₒᵣ, electrical angle ρ_{elec}, the correction values ρ_{correct}, flux control signal V_{d}, etc., without the index i herein, this is for simplification only and the explanations made in connection with the mentioned parameter can be understood as referring the instantaneous parameter values for each of the N mechanical positions into which a single revolution of the rotor can be divided.

The electric motor 102 should be calibrated for the angle offset of the electric angle ρ_{elec} prior to determining the correction values (ρ_{correct}) associated with respective mechanical positions/the pole pairs of the rotor. It is apparent that the electric angle ρ_{elec} should be as accurate as possible as control of the motor torque depends on the electric angle ρ_{elec}. In the proposed iterative positional nonlinearity compensation method, any residual error of the angle offset of the electric angle ρ_{elec} does not affect the iterative positional nonlinearity compensation method and the determination of the correction values (ρ_{correct}) associated with respective mechanical positions/the pole pairs of the rotor for the compensating table 108. This is because the constant offsets of the electric angle ρ_{elec} will be cancelled in the iterative positional nonlinearity compensation method disclosed herein. Therefore, the correction of the electric angle offset is not discussed herein in further detail.

In embodiments of the disclosure, the iterative positional nonlinearity compensation method may be performed with the electric motor 102 rotating freely at a constant speed, i.e., at a setpoint angular velocity. Due to the rotational nonlinearity, the angular velocity will also oscillate around the setpoint speed value as the closed-loop control system 100 assumes the position sensor 106 to operate in an ideally linear fashion. It is noted that the iterative positional nonlinearity compensation method does not require an additional external equipment or additional sensors for finding the correction values for cancelling rotational nonlinearity. The iterative positional nonlinearity compensation method according to the embodiments of the disclosure may be for example used during the calibration phase of the electric motor 102 (e.g., as part of motor production) or during a regular maintenance procedure.

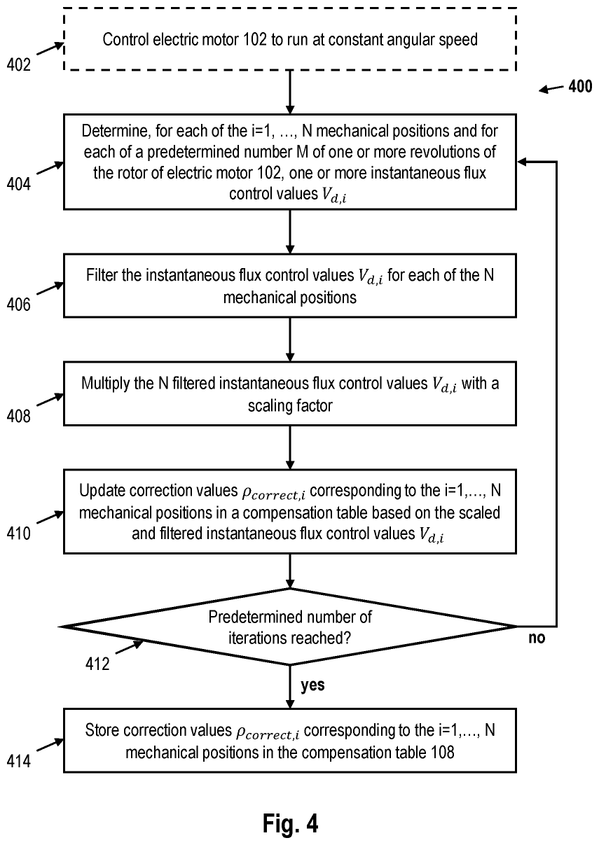

FIG. 4 shows an iterative positional nonlinearity compensation method according to an embodiment of the disclosure. The iterative method 400 of FIG. 4 obtains correction values ρ_{correct,i} for compensating positional non-linearity of a rotor of an electric motor 102, e.g., a synchronous electric motor. As noted above, it is assumed that a single revolution of the rotor of the electric motor 102 is divided into N mechanical positions. As noted above, the number N of mechanical positions may be an integer multiple n of the number p of pole pairs, i.e., N=n·p, where n>2. The electric motor 102 may comprise a p≥2 pole pairs. In an example embodiment, p≥20 and in another embodiment p≥28, but the disclosure is not limited to those example numbers of pole pairs. The N mechanical positions essentially define the angular granularity of the FOC control by dividing the full revolution equivalent to 360° in smaller portions referred to as mechanical positions. It may be assumed that the FOC operation frequency is sufficiently high to provide at least one reading ρₛₑₙₛₒᵣ of the position sensor 106 for each of the N mechanical positions in a single revolution of the rotor.

As regards an example for a practical upper limit, the angular range of the full revolution covered by one mechanical position may be—for example—smaller than or equal to 5°. In one example implementation, angular range corresponding to one mechanical position is smaller or equal to 2.5°. The higher the FOC operation frequency, the smaller the angular range of the full revolution equivalent to one mechanical position may be, but from a practical point of view an example lower limit for the angular range may be larger or equal to 0.25° or larger or equal to 0.50°. In another exemplary implementation, 1440≥N≥70. In another exemplary implementation, as regards the lower limit, 720≥N≥120. In yet another exemplary implementation, as regards the lower limit, 540≥N≥160. In one implementation example, the electric motor 102 has 28 pole pairs and N=6·28=168.

The electric motor 102 may be controlled to run 402 at a constant speed, e.g., a constant number of turns of the rotor per unit time. In general, the filtering method 400 (and method 500 and any of their variants) may be used across the whole speed range of operation for a certain motor type. However, the speed of the electric motor 102 in step 402 should not be too high, as higher angular velocities require higher motor currents to maintain a constant velocity which may possibly adversely affecting the results in determining the correction values ρ_{correct,i} for the rotational nonlinearity compensation. Too low angular velocities may however increase the duration required to determine the correction values ρ_{correct},i. Therefore, method 400 may be performed at a relatively low speed of the electric motor 102, e.g., at or around 500 rpm. In general, the electric motor 102 may be controlled at a setpoint speed which is in between 200 rpm (inclusive) and 1000 rpm (inclusive). However, also lower speeds such as for example 100 rpm or 50 rpm could be used, depending on the implementation and/or motor type. Motor control may be based on a FOC scheme as outlined, for example, in connection with FIG. 1 above. The method 400 is however not limited to the FOC example of FIG. 1 and other variants of position-sensor controlled FOC implementations or vector control implementations using a flux control signal controlling the magnetic flux in the electric motor 102 could be used. It is assumed for exemplary purposes only that the method 400 employs a FOC scheme that uses a flux control signal, e.g., the flux control signal V_{d} as discussed in connection with FIG. 1, to control the magnetic flux in the electric motor 102. The FOC scheme may update the flux control signal with a frequency that is an integer multiple times higher than the 1/N, where N is the number of mechanical positions. For example, the FOC scheme may operate at a frequency of 8 kHz or higher. For instance, in the example of FIG. 2, the frequency (PWM) of the FOC control is 10 kHz, but this is only an example. Prior to entering into block 404 the initial values of the correction values ρ_{correct,i} representing the angular error θ_{err,i} of the rotor corresponding to the N mechanical positions may be initialized to a predetermined value (e.g., zero) prior to step 404.

According to method 400, one or more instantaneous flux control values V_{d,i} are determined 404 for each of the i=1, . . . , N mechanical positions and for each of a predetermined number M of one or more revolutions of the rotor of electric motor 102 running at the constant speed, using the FOC scheme. The FOC scheme's operation frequency may be such that one or more positions sensor readings ρₛₑₙₛₒᵣ,¿ are provided for each mechanical position i=1, . . . , N in a single revolution of the rotor. If the position sensor 106 provides P≥1 sensor readings per rotor revolution, N·M·P position signals ρₛₑₙₛₒᵣ are used to determine N·M·P instantaneous flux control values Vai. The instantaneous flux control values V_{d,i} are based on respective position signals ρₛₑₙₛₒᵣ provided by the position sensor 106 which are indicative of the absolute position of the rotor of the electric motor 102 corresponding to the N mechanical positions and the predetermined number M of one or more revolutions. Hence, there are M·P position signals ρₛₑₙₛₒᵣ (e.g., M position signals ρₛₑₙₛₒᵣ for P=1) for each of the N mechanical positions. The predetermined number M of revolutions in step 404 may be in the range of (inclusive) 1 to (inclusive) 100, but the method 400 is not limited in this respect. For example, the number of revolutions may be selected from the range M ∈[10,30], but this is only an example. The number M of revolutions directly translates into the amount of position sensor data (M times more position sensor data) that are obtained and used to find the correction values. Higher numbers M of revolutions may thus improve the accuracy of the correction values, which may be relevant if the position sensor signals are noisy. For example, the number M may be selected depending on the noise level in sensor output signal.

Next, the M·P instantaneous flux control values Vai determined 404 for each of the N mechanical positions are filtered 406 to obtain a respective filtered instantaneous flux control value V̅_{d,i} representing oscillation of the magnetic flux for each of the N mechanical positions. In general, the filtering 406 may be used to remove the electric harmonic oscillations in the instantaneous flux control values V_{d} determined in block 404. The filtering 406 may not be performed for M. P=1. In one example embodiment, the filtering 406 may perform binning of the instantaneous flux control values V_{d,i}. For example, the filtering 406 may include averaging the M·P instantaneous flux control values V_{d,i} determined 404 for each of the N mechanical positions to obtain a respective filtered instantaneous flux control value V̅_{d,i} representing oscillation of the magnetic flux for each of the N mechanical positions. Alternatively, filtering 406 may include obtaining the mean value of the M·P instantaneous flux control values Vat determined 404 for each of the N mechanical positions and using the mean value as the filtered instantaneous flux control value V̅_{d,i} representing oscillation of the magnetic flux for each of the N mechanical positions.

N filtered instantaneous flux control values V̅_{d,i} are further multiplied 408 with a scaling factor. The scaling factor may be considered equivalent to an amplification factor in classic proportional closed loop feedback control systems. The proper setting of the scaling factor may for example influence the speed of the method 400 converging on the “optimal” correction values ρ_{correct,i} for the N mechanical positions. The scaling factor should be small enough to not cause divergence and large enough that the successive approximation converges quickly. The scaling factor may be dependent on the motor structure of the electric motor 102 and/or may be determined empirically. In some embodiments of the disclosure, the scaling factor is set so as to correspond be in the range from (inclusive) 0.1°el/V and (inclusive) 20 °el/V. For example, the scaling factor may be set so as to correspond to a value of 2 °el/V.

The (current) correction values ρ_{correct,i} corresponding to the N mechanical positions are updated 410 based on the scaled and filtered instantaneous flux control values V̅_{d,i}. For example, this updating 410 may be realized by adding the scaled and filtered instantaneous flux control values V̅_{d,i} to the

$${ρ}_{correct , i}^{current}$$

currently in the compensation table for the respective N mechanical positions,

$$i . e . , {ρ}_{correct , i}^{new} = {ρ}_{correct , i}^{current} + s \cdot {\overline{V}}_{d , i} ,$$

where V̅_{d,i} is the filtered instantaneous flux control value (of the current iteration) obtained in block 406 and s represents the scaling factor applied in block 408. The updated ρ_{correct,i} corresponding to the N mechanical positions may be (temporarily) stored 412 in the compensation table 108 for immediate use by the motor control system 100 to control the electric motor 102.

The steps in blocks 404-410 are repeated a predetermined number of times. Accordingly, the correction values ρ_{correct,i} corresponding to the N mechanical positions updated 410 in each iteration until reaching 412 the predetermined number of iterations. Step 412 checks whether the predetermined number of iterations is reached and branches to 412 if yes, and to step 404 for another iteration if no. The iterative method 400 may converge to “optimal” correction values ρ_{correct,i} corresponding to the N mechanical positions relatively fast. The predetermined number of iterations may be in the range (inclusive) 3 to (inclusive) 20. For example, in some example embodiments, the predetermined number of iterations of the steps in blocks 404-410 is in the range (inclusive) 7 to (inclusive) 10. Notably, the step 408 may not be a separate step, but may also be part of the update in block 410. The number of iterations may also depend on the scaling factor used in step 408, as this factor also influences the convergence of the method 400.

The table below exemplarily shows how the correction values ρ_{correct,i} for the N mechanical positions (first column) are updated in the iterations of the steps in blocks 404-410 in an exemplary compensation table 108, wherein the superscript iter of the correction values

$${ρ}_{correct , i}^{iter}$$

and filtered instantaneous flux control values

$${\overline{V}}_{d , i}^{iter}$$

represents the iteration (or a total of X iterations) in which the respective value is obtained. The index i represents to the respective mechanical positions to which the value corresponds. The parameter s denotes the scaling factor applied in step 408.

| | Iteration 1 | Iteration 2 | | Iteration X |
|---|---|---|---|---|
| 1 | ${ρ}_{correct , 1}^{1} = s \cdot {\overline{V}}_{d , 1}$ | ${ρ}_{correct , 1}^{2} = {ρ}_{correct , 1}^{1} + s \cdot {\overline{V}}_{d , 1}^{2}$ | ... | ${ρ}_{correct , 1}^{X} = {ρ}_{correct , 1}^{X - 1} + s \cdot {\overline{V}}_{d , 1}^{X}$ |
| 2 | ${ρ}_{correct , 2}^{1} = s \cdot {\overline{V}}_{d , 3}$ | ${ρ}_{correct , 2}^{2} = {ρ}_{correct , 2}^{1} + s \cdot {\overline{V}}_{d , 2}^{2}$ | ... | ${ρ}_{correct , 2}^{X} = {ρ}_{correct , 2}^{X - 1} + s \cdot {\overline{V}}_{d , 2}^{X}$ |
| 3 | ${ρ}_{correct , 3}^{1} = s \cdot {\overline{V}}_{d , 3}$ | ${ρ}_{correct , 3}^{2} = {ρ}_{correct , 3}^{1} + s \cdot {\overline{V}}_{d , 3}^{2}$ | ... | ${ρ}_{correct , 3}^{X} = {ρ}_{correct , 3}^{X - 1} + s \cdot {\overline{V}}_{d , 3}^{X}$ |
| ... | ... | ... | ... | ... |
| N | ${ρ}_{correct ,}^{N} = s \cdot {\overline{V}}_{d , N}$ | ${ρ}_{correct , N}^{2} = {ρ}_{correct , N}^{1} + s \cdot {\overline{V}}_{d , N}^{2}$ | . . . | ${ρ}_{correct , N}^{X} = {ρ}_{correct , N}^{X - 1} + s \cdot {\overline{V}}_{d , N}^{X}$ |

The correction values

$${ρ}_{correct , i}^{X}$$

obtained after having performed the predetermined number of iterations may represent the “optimal” correction values for the N mechanical positions and may be permanently stored 414 in the compensation table 108. After having stored correction values

$${ρ}_{correct , i}^{X}$$

as the final correction values in the compensation table 103 of the control system 100 the method 400 ends. Subsequently, the electric motor control system 100 may refer to those final correction values

$${ρ}_{correct , i}^{X}$$

in compensation table 108 for correcting the sensor readings from the position sensor 106 as exemplary outlined in connection with FIG. 1 above.

In the embodiment of FIG. 4, the method 400 performs a predetermined number of iterations. The predetermined number may be set to a given number of iterations, as outlined above. Alternatively, step 412 may also check for a convergency criterion being met, and if yes iteration of steps 404 to 410 is interrupted, and the method proceeds with step 414. Further alternatively, a combination of a predetermined number of iterations and a convergency criterion can be used: Iterations are stopped either upon meeting the convergency criterion or upon reaching the predetermined number of iterations. The convergency criterion may be for example based on the standard deviation σ calculated for the filtered and scaled flux control signals s·V̅_{d,i} under application of the correction values

$${ρ}_{correct , i}^{j}$$

in the j^{th} iteration (with j∈[1, . . . , iterₘₐₓ−1] and it may be checked whether this standard deviation σ^{j} is smaller than (or equal to) a threshold standard deviation σₜₕᵣₑₛₕ, i.e., σ^{j}≤σₜₕᵣₑₛₕ, where iterₘₐₓ is the predetermined number of iterations. The threshold standard deviation σₜₕᵣₑₛₕ may be for example equal to or below 1%. In one example, the threshold standard deviation σₜₕᵣₑₛₕ≤0.5% or σₜₕᵣₑₛₕ≤0.25%. In this case, the method 400 may further comprise calculating the standard deviation σ^{j} for the correction values

$${ρ}_{correct , i}^{j}$$

obtained in the respective current iteration j and comparing the standard deviation σ^{j} to the threshold standard deviation σₜₕᵣₑₛₕ. If σ^{j}≤σₜₕᵣₑₛₕ, step 412 branches to step 414 and to step 404 otherwise. Alternatively, the method 400 may further comprise determining in step 412 whether the predetermined number of iterations is reached and branches to 414 if yes; if no, the standard deviation σ^{j} for the filtered and scaled flux control signals s·V̅_{d,i} under application of the correction values

$${ρ}_{correct , i}^{j}$$

obtained in the respective current iteration j is calculated and compared to the threshold standard deviation σₜₕᵣₑₛₕ. If σ^{j}≤σₜₕᵣₑₛₕ, the variant of method 400 branches to step 414 and to step 404 otherwise. Further alternatively, checking if σ^{j}≤σₜₕᵣₑₛₕ can be performed prior to checking whether the predetermined number of iterations is reached.

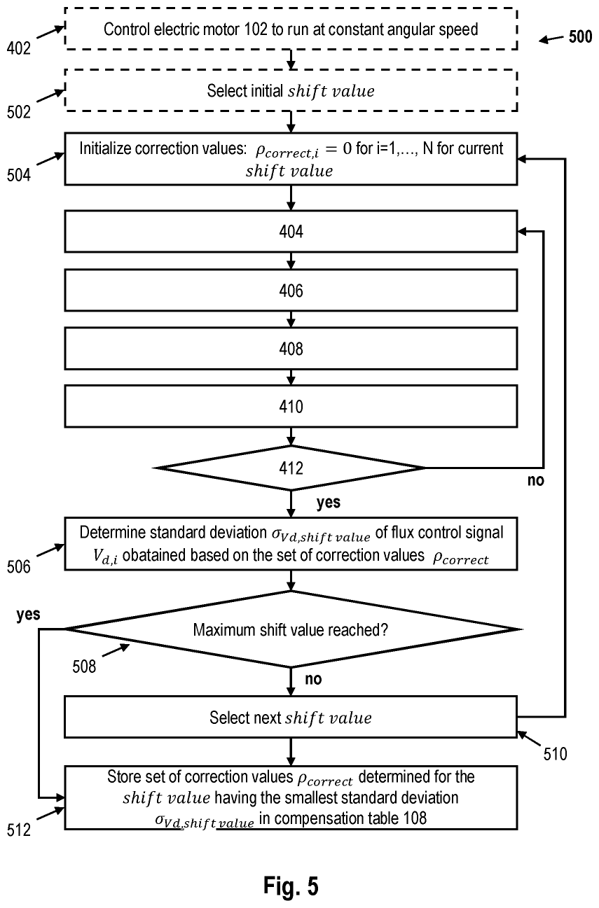

FIG. 5 shows another iterative positional nonlinearity compensation method according to an embodiment of the disclosure. The iterative method 500 of FIG. 5 also obtains correction values ρ_{correct,i} for compensating positional non-linearity of a rotor of an electric motor 102, e.g., a synchronous electric motor. The method 500 in FIG. 5 is based on method 400 in FIG. 4 or any of its variations discussed herein and may be considered an extension of the method 400 or any of its variations. The steps of FIG. 5 corresponding to steps in FIG. 4 are marked with the same reference numeral and their description is not repeated in full.

The main “difference” between the method 500 shown in FIG. 5 and the method 400 in FIG. 4 is that steps 404-410 may be repeatedly performed for each of multiple shift values to obtain a set of correction values ρ_{correct} for each given shift value. In principle, FIG. 4 may be considered a simplification of the method 500 in FIG. 5 if there is only one shift value (equal to zero). Finally, the optimal set of correction values ρ_{correct} of one of the shift values can be selected as the final set of correction values ρ_{correct} that will be stored in the compensation table 108. The shift values substantially correspond to different shifting angles which may be related to the time delay and resulting equivalent phase shift between the actual measurement of the positions sensor 105 producing the sensor reading ρₛₑₙₛₒᵣ, and availability of the sensor reading ρ_{sensor,i} or the corresponding electrical angle sensor reading ρ_{elec,i} in the FOC control loop. The shift value granularity may be small, e.g., the range between inclusive 0° and inclusive 20° of the mechanical angle of the rotor.

Similar to FIG. 4, the electric motor 102 is controlled 402 by the FOC scheme to run at constant speed. Further, the initial shift value may be selected 502 or initialized (e.g., by setting it to zero). In principle, the iteration through the shift values can also start from the predetermined highest shift value and the shift value can be decreased until reaching the lowest shift value (e.g., equal to zero). Further, the correction values ρ_{correct,i} corresponding to the N mechanical positions are initialized 504 by (re-)setting them to zero, so that new correction values ρ_{correct,i} are generated for each new shift value by performing the steps 404 to 412 of method 400 (or any of their variations discussed herein). Once it is determined in step 412 to stop the iterations of steps 404-410 in response to reaching the predetermined number of iterations and/or checking a convergency criterion, the method 500 proceeds to step 506 (instead of step 414 as in FIG. 4).

The method 500 determines 506 the standard deviation σ_{Vd.shift value} of the filtered and scaled flux control signals s. Vat obtained by the FOC system 100 under application of the set of correction values ρ_{correct} that has been determined as the result of the iterations of steps 404-410 for the current shift value. Notably, the set of correction values ρ_{correct,i} that has been determined as the result of the iterations of steps 404-410 for the given shift value may be stored in an (temporary) compensation table in step 410, wherein the mechanical position i for which the respective of correction values ρ_{correct,i} are stored (temporarily) in the compensation table 108 may be cyclically shifted based on the current shift value. The standard deviation Ova, shift value of the filtered and scaled flux control signals s. Vat obtained by the FOC system 100 under application of the set of correction values ρ_{correct} for the given shift value is also stored in association with the set of correction values ρ_{correct} for the given shift value for later use. As explained below in more detail, when (temporarily) storing the set of correction values ρ_{correct} in the (temporary) correction table 108, the set of correction values ρ_{correct} obtained for the N mechanical positions is stored at a cyclically shifted position corresponding to a shifted mechanical position. Hence, a respective scaled and filtered instantaneous flux control value s·V̅_{d,i} obtained by the FOC system 100 for the mechanical position i updates 410 the correction value ρ_{correct,(i+shift value)MOD N}, i.e., an entry of the compensation table corresponding to the ((i+shift value)MOD N)^{th} mechanical position, where MOD is the modulo operation. The method 500 further checks 508, whether the maximum shift value has been reached and branches to step 512 if yes. If no, the next shift value (e.g., shift value=shift value+1) is selected 510 and the steps 504, 404-506 are repeated for this new shift value.

When the maximum shift value to be tested has been reached 508, the method 500 selects the set of (cyclically shifted) correction values ρ_{correct} in the (temporary) correction table corresponding to the shift value for which the smallest standard deviation σ_{Vd,shift value} of the filtered and scaled flux control signals s·V̅_{d,i} obtained by the FOC system 100 under application of the set of correction values ρ_{correct} has been determined in step 506. This selected set of (cyclically shifted) correction values ρ_{correct} is stored 512 as a final set of correction values ρ_{correct} in the correction table 108. Subsequently, the electric motor control system 100 may refer to this final set of correction values ρ_{correct} in compensation table 108 for correcting the sensor readings from the position sensor 106 as exemplary outlined in connection with FIG. 1 above.

The table below exemplarily shows how the cyclic shift of the correction values ρ_{correct,i} in an exemplary (temporary) compensation table for the N mechanical positions (first column), wherein the superscript shift of the correction values

$${ρ}_{correct , i}^{shift}$$

in the last iteration of steps 404-410 (iteration X in the table above) for the given shift value shift. The maximum shift value is Sₘₐₓ in this example. The index i represents to the respective mechanical positions for which the value has been determined. The standard deviation σ_{Vd,shift value} of the filtered and scaled flux control signals s·V̅_{d,i} obtained by the FOC system 100 under application of the correction values ρ_{correct,i} in the respective columns corresponding to the shift values is indicated at the bottom of each column.

| | Shift Value = 0 | Shift Value = 1 | Shift Value = 2 | | Shift Value = Sₘₐₓ |
|---|---|---|---|---|---|
| 1 | ${ρ}_{correct , 1}^{0}$ | ${ρ}_{correct , N}^{1}$ | ${ρ}_{correct , N - 1}^{2}$ | ... | ${ρ}_{correct , {S}_{max} - 4}^{2}$ |
| 2 | ${ρ}_{correct , 2}^{0}$ | ${ρ}_{correct , 1}^{1}$ | ${ρ}_{correct , N}^{2}$ | ... | ${ρ}_{correct , {S}_{max} - 3}^{2}$ |
| 3 | ${ρ}_{correct , 3}^{0}$ | ${ρ}_{correct , 2}^{1}$ | ${ρ}_{correct , 1}^{2}$ | ... | ${ρ}_{correct , {S}_{max} - 2}^{2}$ |
| 4 | ${ρ}_{correct , 4}^{0}$ | ${ρ}_{correct , 3}^{1}$ | ${ρ}_{correct , 2}^{2}$ | | ${ρ}_{correct , {S}_{max} - 1}^{2}$ |
| ... | ... | ... | ... | ... | ${ρ}_{correct , {S}_{max}}^{2}$ |
| ... | ... | ... | ... | ... | ... |
| ... | ... | ... | ... | ... | ${ρ}_{correct , 1}^{2}$ |
| ... | ... | ... | ... | ... | ${ρ}_{correct , 2}^{2}$ |
| N | ${ρ}_{correct , N}^{0}$ | ${ρ}_{correct , N - 1}^{1}$ | ${ρ}_{correct , N - 2}^{2}$ | ... | ${ρ}_{correct , 3}^{2}$ |
| | σ_{Vd,0} | σ_{Vd,1} | σ_{Vd,2} | ... | σ_{Vd,S}_{ₘₐₓ} |

Assuming for example that the standard deviation σ₂ for the shift value=2 is the smallest standard deviation, step 512 would select the set of correction values

$${ρ}_{correct , i}^{2}$$

as cyclically shifted in the table above as final set of correction values

$${ρ}_{correct , i}^{2}$$

and would store those values in the compensation table 106. The table below shows an example of the resulting compensation table 106.

| Mechanical position | Correction value |
|---|---|
| 1 | ${ρ}_{correct , N - 1}^{2}$ |
| 2 | ${ρ}_{correct , N}^{2}$ |
| 3 | ${ρ}_{correct , 1}^{2}$ |
| 4 | ${ρ}_{correct , 2}^{2}$ |
| ... | ... |
| ... | ... |
| ... | ... |
| ... | ... |
| N | ${ρ}_{correct , N - 2}^{2}$ |

In the example tables above, the shift value S may be assumed to lie in the range [0, 1, 2, . . . , Sₘₐₓ] and the update 510 of the shift values increments the shift value until reaching Sₘₐₓ. In this case, the step of the shift values is 1 and corresponds to an angle shift of 360/N ° (in terms of mechanical angle). Of course, other step sizes of the shift values for storing the correction values ρ_{correct,i} in an (temporary) compensation table may be used, so that the corresponding angle shift between the shift values would correspond to step size·360/N °.

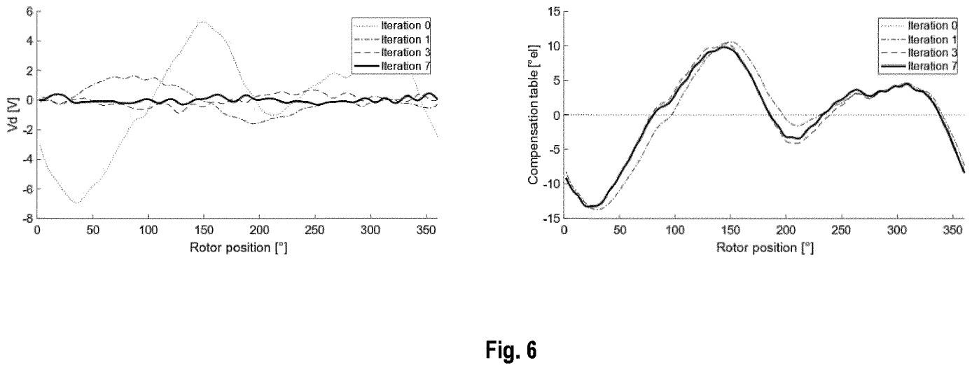

The whole iterative method in the methods 400 and 500 (and any of their variations) may require only about 50-1000 mechanical revolutions of the electric motor 102 in total, depending on the number M of revolutions of the motor, the number Sₘₐₓ of shift values checked and the predetermined number of iterations performed for each shift value. The methods 400 and 500 (and any for their variations) quickly converge on the “optimal” correction values ρ_{correct,i} within only a few iterations as shown in FIG. 6, which shows the resulting fluctuations of the flux control signal V_{d} on the left for iterations 0, 1, 3 and 7 (assuming 7 iterations of steps 404-410). On the right-hand side of FIG. 6, the correction values ρ_{correct,i} for a full revolution of the rotor after 1, 3, and 7 iterations of steps 404-410, respectively, are shown. The corresponding standard deviation ova of the flux control signal V_{d} before applying the rotational nonlinearity compensation was about 4.4%, and drops to 1.2%, 0.47%, and 0.23%, after 1, 3, and 7 iterations, respectively, in the example case depicted in FIG. 6. This represents an improvement factor of 19, which can be represented as an increased position sensor accuracy for more than 4 bits.

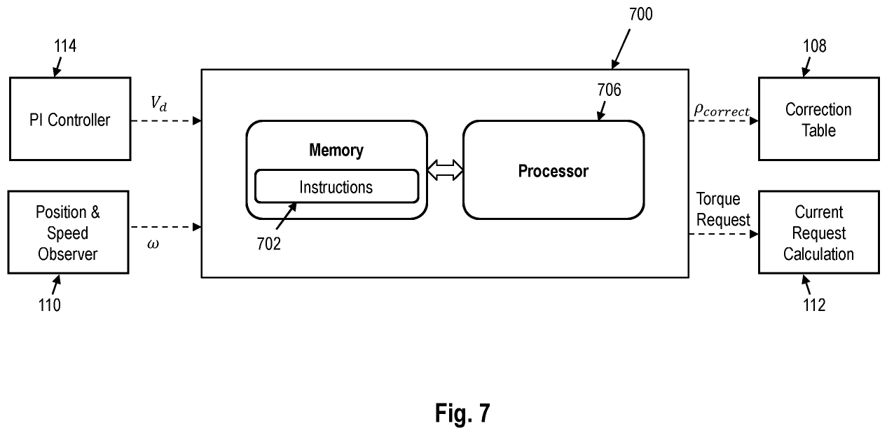

Another aspect of the disclosure is the realization of the methods 400 and 500 and any of their variations described herein in software and/or hardware. For example, the methods 400 and 500 and any of their variations described herein may be implemented in a software program by means of instructions. As shown in FIG. 7, the instructions 702 may be for example stored on one or more computer-readable media, e.g., realized by a memory 704, of a device 700. The device 700 may for example comprise a processor 706 that may access the instructions 702 in memory 704 and may execute the instructions 702 to thereby cause the device 700 to perform the method 400 or method 500 (or any of their variants described herein). The device 700 may be for example a calibration device or part of a calibration device for calibrating the electric motor 102.

The device 700 may be coupled to the motor control system 100. The device 700 may receive the instantaneous flux control signals V_{α} output by the PI controller 114 and the motor speed w from the Position & Speed Observer block 110. The device 700 may provide the current request calculation block 112 of the motor control system 100 with the torque request to control the motor speed w to a constant setpoint speed. Furthermore, the device 710 updates the correction table 108 (step 410) with the current set of determined correction values ρ_{correct,i} so that the motor control system 100 can instantaneously use those updated correction values ρ_{correct} for the FOC and calculate the instantaneous flux control signals V_{α} based on the updated correction values ρ_{correct}.

In the embodiments described herein, the correction table 108 stores correction values ρ_{correct} which are used by the control system 100 to correct the sensor readings ρₛₑₙₛₒᵣ received from the position sensor 106.

The various embodiments described above can be combined to provide further embodiments. All of the patents, applications, and publications referred to in this specification and/or listed in the Application Data Sheet are incorporated herein by reference, in their entirety. Aspects of the embodiments can be modified, if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. An iterative method for obtaining correction values for compensating positional non-linearity of a rotor of a synchronous electric motor, a single revolution of the rotor being divided into N mechanical positions, wherein the iterative method comprises:
(1) controlling the electric motor to run at a constant speed based on a field-oriented control scheme, the field-oriented control scheme using a flux control signal that controls a magnetic flux in the electric motor;
(2) determining, for each of i=1, . . . , N mechanical positions and for each of a predetermined number M of one or more revolutions of the rotor of electric motor running at the constant speed, one or more instantaneous flux control values using the field-oriented control scheme, wherein the instantaneous flux control values are based on respective position signals indicative of an absolute position of the rotor of the electric motor corresponding to the N mechanical positions and the predetermined number M of one or more revolutions;
(3) filtering the instantaneous flux control values determined in step (2) for each of the N mechanical positions to obtain a respective filtered instantaneous flux control values V_{d},i representing oscillation of the magnetic flux for each of the N mechanical positions;
(4) multiplying the N filtered instantaneous flux control values V_{d},i with a scaling factor;
(5) updating correction values for an angular error of the rotor corresponding to the N mechanical positions in a compensation table based on the scaled and filtered instantaneous flux control values; and
(6) repeating steps (2) to (5) using the updated correction values for an angular error of the rotor in the compensation table until reaching a predetermined number of iterations.

2. The iterative method of claim 1, wherein steps (2) to (6) are repeated for each of a plurality of shift values to obtain a compensation table storing a respective set of updated correction values for an angular error of the rotor corresponding to the N mechanical positions for each of the shift values;
wherein the correction values for an angular error of the rotor in the compensation table are reset to zero for each of the shift values before repeating steps (2) to (6) for the respective shift value; and
wherein in step (5) each of the correction values for an angular error of the rotor corresponding to a respective scaled and filtered instantaneous flux control value at a given mechanical position i is updating a shifted entry of the compensation table corresponding to the ((i+shift value)MOD N)^{th} mechanical position.

3. The iterative method of claim 2, further comprising the following steps performed in the last iteration of the predetermined number of iterations for the different shift values:
(7) for each of the shift values, determining a standard deviation of the N scaled and filtered instantaneous flux control values determined in the last iteration for the respective shift value, and
(8) storing, for each of the shift values, the set of updated correction values for an angular error of the rotor corresponding to the N mechanical positions for the respective shift value and the standard deviation of the updated correction values for an angular error of the rotor determined for the respective shift value in the compensation table.

4. The iterative method of claim 3, further comprising selecting the set of correction values for an angular error of the rotor corresponding to the N mechanical positions corresponding to the shift value that results in the smallest standard deviation of the N scaled and filtered instantaneous flux control values as a final set of correction values for an angular error of the rotor corresponding to the N mechanical positions; and
storing the selected set of correction values for an angular error of the rotor corresponding to the N mechanical positions in a final compensation table in a non-volatile memory for control of the magnetic flux in the electric motor based on the field-oriented control scheme.

5. The iterative method of claim 1, wherein the filtering in step (3) comprises removing electric harmonic oscillations from the instantaneous control values determined for the N mechanical positions to smooth the instantaneous control values determined for the N mechanical positions.

6. The iterative method of claim 5, wherein the electric harmonic oscillations are removed from the instantaneous control values determined for the N mechanical positions by digital low-pass filtering.

7. The iterative method of claim 1, wherein the filtering in step (3) further comprises averaging the instantaneous flux control values corresponding to each of the N mechanical positions to obtain the instantaneous control values corresponding to the respective mechanical position.

8. The iterative method according to claim 1, further comprising measuring the position signal indicative of the absolute position of the rotor of the electric motor using a position sensor at a sampling frequency so that at least one instantaneous flux control value is determined in step (2) for each of the N mechanical positions.

9. The iterative method according to claim 1, wherein the electric motor comprises a number p of pole pairs, where p≥2.

10. The iterative method according to claim 1, wherein the number of revolutions of the rotor in each iteration is in a range inclusive 1 to inclusive 100.

11. The iterative method according to claim 1, wherein the predetermined number of iterations is in the range inclusive 3 to inclusive 20.

12. The iterative method according to claim 2, wherein the shift values represent shifts of the mechanical angle of the rotor in the range exclusive 0° to inclusive 20°.

13. A non-transitory computer-readable medium storing instructions that, when executed by a processing unit of an apparatus, cause the apparatus to perform the method according to claim 1.

14. A calibration system for coupling to an electric motor, the calibration system comprising a processing unit and memory storing instructions, wherein the processing unit is configured to execute the instructions stored in memory to cause the calibration system to perform the method according to claim 1.
